(19) United States
(12) Patent Application Publication
(10) Pub. No.: US 2020/0238445 A1
(43) Pub. Date: Jul. 30, 2020

(54) WIRE WELDING AND GRINDING STATION

(71) Applicant: NV Bekaert SA, Zwevegem (BE)

(72) Inventor: Kurt SHAW, Chester, AR (US)

(73) Assignee: NV Bekaert SA, Zwevegem (BE)

(21) Appl. No.: 16/634,947

(22) PCT Filed: Jul. 4, 2018
(86) PCT No.: PCT/EP2018/068041

§ 371 Date: Jan. 29, 2020

(30) Foreign Application Priority Data
Aug. 29, 2017 (EP) 17188334.1

(51) Int. Cl. B23K 37/02; B23K 37/00; B23K 11/28; B23K 11/24; B23K 11/02; H02P 1/16; H02J 7/00

(52) U.S. Cl. CPC B23K 37/0294; B23K 37/006; B23K 11/28; B23K 2101/32; B23K 11/02; H02P 1/16; H02J 7/0047; B23K 11/241

(57) ABSTRACT

A wire welding and grinding station (100) comprises a wire welder (112), an AC electrical motor (114) for powering a metal grinder (116), and an AC power supply (110) for supplying electrical power to both the wire welder (112) and the electrical AC motor (114). The station (100) further comprises a soft start module (118) to reduce inrush current demanded by the electrical AC motor (114) while starting. The use of the soft start module (118) allows using a battery (102) as power supply and the use of a battery as power supply has the advantage of practical movability and stable welding currents.

### TECHNICAL FIELD

The invention relates to a wire welding and grinding station.

### BACKGROUND ART

Wire is commonly available or supplied in discrete lengths. Often it is needed to join two lengths wire in order to reach the demanded length or to allow continuity of process.

Joining two lengths of metal wire like steel wire is usually done by welding followed by a grinding operation.

A flat perpendicular face is formed at the end of each length of wire. The ends of wire are aligned, brought together under pressure to upset them and thereafter electrically heated to a welding temperature so that the ends weld together. The pressure is then maintained until the welded material has solidified. Due to the exercised pressure, the diameter may be increased at the welding point. A grinding is then carried out to reduce the diameter to the original value.

Due to the low thermal inertia of wires that causes rapid heating and cooling down, minor parameter changes during welding result in major changes of the metal structure and of the quality of the weld. So fluctuations in the delivered power supply from the commercial net cause quality variations in the welds.

Another problem is that connection from a welding station to the commercial net requires long electrical cords. The welding station must be movable to allow the welder to be taken to other weld locations. This requires multiple GFCI (ground fault circuit interrupter) electrical supply outlets to be installed in the plant infrastructure so as to be nearby and power cords long enough to allow the welding station to be used within the confines of the work area. The use of cords creates safety hazards for the employees since—due to the movability—they cannot be adequately fixed and protected from being a trip hazard or an electrical hazard due to damage or entanglement by processing equipment.

Additionally, dressing is carried out by a grinder that is powered by an electrical AC motor. As this AC motor demands a high starting-up current, the so-called inrush current, this AC motor also requires direct connection to the electrical net, which adds other long electrical cords and adds to the complexity of the above-mentioned problem.

### DISCLOSURE OF INVENTION

It is a general object of the invention to solve the problems of the prior art.

It is a more specific object of the invention to avoid or to reduce the need for long electrical cords to welding stations and to grinding stations.

It is another object of the invention to provide for a practical and freely movable welding and grinding station.

According to the invention there is provided a single and combined wire welding and grinding station. This station comprising a wire welder, an AC electrical motor for powering a metal grinder, and an AC power supply for supplying electrical power to both the wire welder and the electrical AC motor. The station further comprising a soft start module that can reduce start up time of the grinder electrical AC motor by 2 seconds to reduce inrush current demanded by the electrical AC motor while starting. Without such a soft start module, the starting of the AC motor is accompanied by inrush currents up to seven to ten times the running current. The starting torque can be up to three times higher than the running torque. This increased electrical current stresses the power supply. Soft start modules temporarily reduce the load and torque in the power train and electrical surge during motor start-up.

The terms “wire welding and grinding station” refer to a welding and grinding station for both metal wires and metal cords or metal ropes, e.g. steel wires, steel cords and steel ropes.

The soft start module facilitates to combine the wire welder and the grinder in one single station with one single power supply.

More particularly and preferably, the AC power supply is an inverter that is powered by a battery. The soft start module prevents the inverter from faulting due to overloading. In addition, the soft start module enables a battery to supply power through the inverter to both the wire welder and the electrical AC motor. The presence of a battery eliminates the need for long electrical cord connections. Stated alternatively, the use of the soft start module allows using a battery as power supply and the use of a battery as power supply has the advantage of practical movability and stable welding currents because it is independent of fluctuations of a supplying network.

Preferably a ground fault circuit interrupter is installed between the inverter and the wire welder/electrical AC motor.

The combined wire welding and grounding station according to the invention preferably comprises a battery charge indicator to show an operator when the battery must be recharged.

In preferable embodiment of the invention, the combined wire welding and grounding station is a unit that can be moved easily by a single operator from one working area to another working area without the need to wind and unwind electrical cords and without the need to disconnect and connect again to the commercial electrical net.

In another practical embodiment of the invention, the wire welding and grinding station also comprises a portable cart. This portable cart is designed to hold a backup or spare battery and a battery charger. The cart is used to safely and efficiently move the backup battery from the welding station to a point of power replenishment and vice versa. Only a minimum length of electrical cord is needed.

### BRIEF DESCRIPTION OF FIGURES IN THE DRAWINGS

FIG. 1 shows a general scheme of a combined welding and grinding station according to the invention.

FIG. 2 schematically shows a portable cart as ancillary device for a combined welding and grinding station.

### MODE(S) FOR CARRYING OUT THE INVENTION

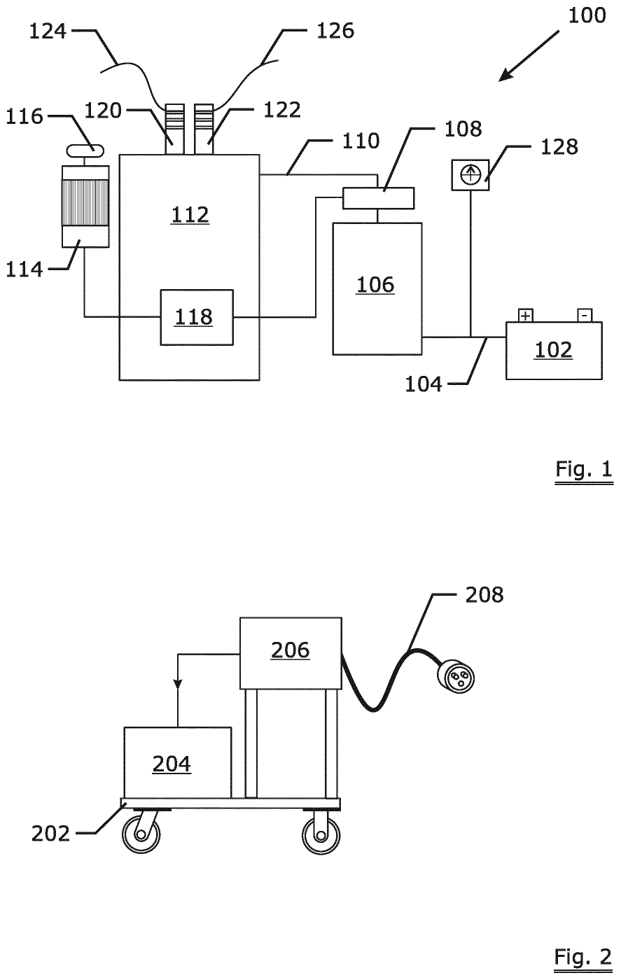

Starting with FIG. 1, a combined welding and grinding station 100 according to the invention has a deep cycle 12 Volt battery 102 that supplies DC current 104 to a 120 Volt power inverter 106. This inverter 106 must be large enough to provide 15 ampere AC needed for providing the desired welds of steel wires. A ground fault circuit interrupter 108 is positioned on the AC connection between the inverter 106 and the rest of the station 100. The inverter provides AC current 110 to the wire welder 112 and the electrical AC motor 114 which drives the grinder 116. The electrical AC motor 114 has a 120 volt soft start module 118 to reduce the inrush current demanded by the electrical AC motor 114 during start-up. The small delay caused by this soft start module 118 has no noticeable impact on the usability. An example of a soft start module would be a Schneider Electric model ATS01N112FT Soft Start Module.

The wire welder 112 is further equipped with two holding dies 120, 122 each of which holds a wire end 124, 126 to be welded together. The holding dies 120, 122 allow to align the wire ends 124, 126, to press them together and to feed them with electrical current to perform the weld. Furthermore, the welding and grinding station 100

Going to FIG. 2, the combined welding and grinding station 100 may also have as auxiliary equipment a portable cart 202 that has a backup battery 204 and a 120 volt battery charger. The backup battery 204 is charged by the 120 volt charger using a minimal length of electrical cord 208 to a standard infrastructure electrical connection. The cart can be safely and efficiently moved from and to the welding and grinding station 100. This has the additional advantage that the welding and grinding station 100 remains at the point of use during power replenishment.

Each welding and grinding station 100 is capable of producing over 40 welds per battery charge, where the exact number depends upon the steel wire diameter. Practice has shown that the welding and grinding station 100 can be used over at least twelve hours.

The welding and grinding station according to the invention is particularly suitable for welding and grinding low-carbon steel wires and high-carbon steel wires, steel cords and steel ropes.

Low-carbon steel wires may have wire diameters ranging from 0.4 mm to 10.0 mm.

High-carbon steel wires may have wire diameters ranging from 0.10 mm up to 15.0 mm and above.

Steel cords comprise several steel filaments that are twisted together. The diameter of the steel filaments ranges from 0.15 mm up to 0.60 mm, e.g. from 0.15 mm to 0.40 mm for tire cord purposes.

The term diameter used here does not necessarily mean that the wires or filaments all have a circular cross-section. The diameter of a non-circular wire or filament is the diameter of a circle having the same cross-section as the non-circular wire or filament.

In case of steel cords, all filaments or only part of them will be welded together.

Low carbon steel wires typically have a carbon content ranging between 0.04 wt % and 0.20 wt %. A complete composition of a low-carbon steel wire may be along following lines: A carbon content of 0.06 wt %, a silicon content of 0.166 wt %, a chromium content of 0.042 wt %, a copper content of 0.173 wt %, a manganese content of 0.382 wt %, a molybdenum content of 0.013 wt %, a nitrogen content of 0.006 wt %, a nickel content of 0.077 wt %, a phosphorus content of 0.007 wt %, a sulphur content of 0.013 wt %, the remainder being iron and unavoidable impurities.

High-carbon steel wires typically have a carbon content ranging from 0.40 wt % to 1.20 wt %, e.g. 0.70 wt % to 1.1 wt %; a manganese content ranging from 0.10 wt % to 1.0 wt %, e.g. from 0.20 wt % to 0.80 wt %; a silicon content ranging from 0.10 wt % to 1.50 wt %, e.g. from 0.15 wt % to 0.70 wt %; a sulphur content below 0.03 wt %, e.g. below 0.01 wt %; a phosphorus content below 0.03 wt %, e.g. below 0.01 wt %, the remainder being iron and possible microalloying elements as chromium, vanadium, molybdenum, copper, niobium in amounts maximum up to 0.4 wt %.

### LIST OF REFERENCE NUMBERS

100 combined welding and grinding station
102 battery
104 DC current
106 inverter
108 GFCI
110 AC current
112 wire welder
114 electrical AC motor
116 grinder
118 soft start module
120 holding die
122 holding die
124 wire end
126 wire end
128 battery charge indicator
202 portable cart
204 spare battery or backup battery
206 volt charger
208 electrical cord

1. A wire welding and grinding station,
said station comprising a wire welder,
an AC electrical motor for powering a metal grinder, and
an AC power supply for supplying electrical power to both said wire welder and said electrical AC motor,
said station further comprising a soft start module to reduce inrush current demanded by said electrical AC motor while starting.

2. The wire welding and grinding station according to claim 1,
said AC power supply being a DC/AC converter,
said station further comprising a battery,
said battery supplying power to said inverter.

3. The wire welding and grinding station according to claim 2,
said station further comprising a ground fault circuit interrupter,
said ground fault circuit interrupter being located between said inverter, on the one side, and the welding electrodes and AC electrical motor, at the other side.

4. The wire welding and grinding station according to claim 2,
said station further comprising a battery charge indicator to show an operator when said battery should be recharged.

5. The wire welding and grinding station according to claim 1,
said station constituting a unit that can be moved by one single operator.

6. The wire welding and grinding station according to claim 2,
said station further comprising a portable cart,
said cart being designed to hold a backup battery and a battery charger.
